(19) United States
(12) Patent Application Publication
(10) Pub. No.: US 2026/0306326 A1
(43) Pub. Date: Oct. 8, 2026

(54) MULTI-PART BED WITH THE ABILITY TO MOVE EACH PART USING A JACK TO FACILITATE WASHING AND BANDAGE REPLACEMENT OF BURN PATIENTS

(71) Applicant: Abbas GHOLAMIDOKOUHAKI, SHIRAZ (IR)

(72) Inventors: Abbas GHOLAMIDOKOUHAKI, SHIRAZ (IR); Farshad ZARE, SHIRAZ (IR)

(21) Appl. No.: 19/598,759

(22) PCT Filed: Aug. 15, 2023
(86) PCT No.: PCT/IB2023/058195

§ 371 Date: Jun. 18, 2026

(51) Int. Cl. A61G 7/057; A61G 7/00

(52) U.S. Cl. CPC A61G 7/0573; A61G 7/0005; A61G 2200/10; A61G 2203/10

(57) ABSTRACT

This multi-piece bed has the ability to move each piece using a jack to facilitate washing and bandage replacement of burn patients. Now using an electrical jack in the middle of each box and two guide pins on both sides, another mechanism is put in place with which we can easily move each part of the bed using these electrical and mechanical pieces.

### TECHNICAL FIELD

This is a multi-part bed designed using the sciences of mechanics and design, in which by lowering different parts, we can facilitate the procedures of washing and bandage replacement for burn patients.

### BACKGROUND ART

By studying the patents registered in Intellectual Property System, the differences of current disclosure and similar projects are listed below:
1) Design and build of a chair to prevent and/or removal of foot movement limitations for burn patients.—Registration Number 53490—Date: Oct. 8, 2008

This disclosure is a chair, varying in size, that alleviates foot movement limitations for burn patients and the patient themself can adjust it, optimizing the time for physiotherapy.
2) Under-arm-and-foot mattress and inflatable backrest for burn patients.—Registration Number 73322—Date: Aug. 8, 2011

This disclosure relates to a mattress designed to increase the pace of treatment and lower the overall costs.
3) Preparation of herbal ointment for the treatment of burn wounds of diabetics patients using bitter and sweet almond extract.—Registration Number 70771—Date: May 22, 2011

This disclosure relates to a medicinal herbal ointment used to treat burn wounds.

### SUMMARY

This multi-piece bed with the ability to move each piece using a jack to facilitate washing and bandage replacement of burn patients was designed based on science of mechanics. Currently, severe burn patients usually are unable to move by themselves and their burns need to be washed and their bandages need to be replaced on a weekly basis. This procedure needs to be done by medical professionals during which they need to relocate the patient for better accessibility to the burns. This relocation of patient can cause bruises and similar problems for the patient and can also put the medical professionals in a tough situation regarding the weight of the patient. In the past, another hospital bed, shared some similarities to this one in which the operator could apply force by their foot to a handle that would lower or raise different pieces of the bed. This operation involved many mechanical pieces which created challenges such as unexpected stop of function during operation and malfunction of pieces, like broken shafts and connections. Another challenge of the previous method is the low speed of the mechanism. Now using an electrical jack in the middle of each box and two guide pins on both sides, another mechanism is put in place with which we can easily move each part of the bed using these electrical and mechanical pieces.

### DETAILED DESCRIPTION

Severe burn patients usually are unable to move by themselves but they need to wash the burns and replace the bandages weekly. This procedure needs to be done by medical professionals during which they need to relocate the patient for better accessibility to the burns. This relocation of patient can cause bruises and similar problems for the patient and can also put the medical professionals in a tough situation regarding the weight of the patient. In the past, another hospital bed, shared some similarities to this one in which the operator could apply force by their foot to a handle that would lower or raise different parts of the bed. This operation involved many mechanical pieces which created challenges such as unexpected stop of function during operation and malfunction of pieces, like broken shafts and connections. Another challenge of the previous method is the low speed of the mechanism.

Addressing to these challenges, the present disclosure intends to change the moving mechanism of each part of this bed. Using an electric jack, the movement of each part can be done in an electromechanical operation. This medical bed includes the main parts of the body and frame, protections all around the bed, jack, connections related to its movement, covers for the jack, guide shaft and bushings, and shaft head.

The length, height and size of the bed are similar to the hospital bed standards. Four longitudinal pillars are located on both sides of the frame acting as the longitudinal columns with two on the top (Page 1, Part 6) and two on the bottom (Page 1, Part 9), situated on left and right side of the frame. These pillars are connected at the corners of the bed using reinforced L support bracket (Page 1, Parts 20 & 13). This is the cuboid main frame of the bed. Around the bed will be covered and enclosed using covers (Page 1, Parts 19 & 21). Each part of the bed includes a jack, two guide pins, two pairs of shaft heads, two pairs of bushings, a pair of pieces connecting the bushings to the box and the mattress. Each box is connected to each part of the mattress (Page 1, Part 23) using reinforced plates (Page 1, Part 17). The latitudinal reinforcing chassis (Page 1, Part 16) is located under the mattress in the middle of the box. Inside this chassis there are eyelets (Page 1, Part 3) used to connect to the axle of the jack in order to lower or raise the bed.

The jack and the pieces of its motor and gearbox (Page 1, Part 2) are located on the chassis or the main frame (Page 1, Part 5) in the middle of the bed. On both sides of each box there are guide pins (Page 1, Part 18). On the sides of these pins, there are the shaft heads one on the top and another on the bottom (Page 1, Part 25) used for stabilizing the connection to the bed's longitudinal pillars (Page 1, Parts 6 & 9). In each guide pin there is also a pair of bushings (Page 1, Part 22). These bushings are connected to the box's frame using aluminum plates (Page 1, Part 28).

These connections result in the smooth movement of each box when receiving lowering or raising order from the pedals (Page 1, Part 10). The whole box is lowered or raised using the jack in the middle of the box, leveraging the bushings and guide pins on both sides.

In the front and end of the bed are two handles (Page 1, Part 8) used for transportation of the bed. The bed is designed in a way that can keep the patient's head in place while moving the other six parts separately. This feature facilitates the procedure of washing the patient's wound or changing their bandage without the need for moving the patient.

The head rest part of the bed is covered using metal plates (Page 1, Parts 15 & 26), on top of which lays the mattress (Page 1, Part 14). The control box (Page 1, Part 7) is located underneath.

The bed has four wheels (Page 1, Part 27), each located at a corner.

There are hand rests (Page 1, Part 12) on both sides of the bed that the patient can put their hand on. The hand rests are bolted to the frame of the bed using a rail (Page 1, Part 11). This rail can be adjusted depending on the the patient's posture and hand length.

The hand rests (Page 1, Part 12) on the rail can be adjusted. It is possible to use any type of electric jack that converts rotary movement into linear, such as electric hospital bed jacks (actuator) and book jacks with electric motors (motorize).

At the bottom of the bed, there are two support legs (Page 1, Part 4) for better control over the pedals and also to keep the personnel away from the moving parts of the bed.

For each moveable part of the bed, there are two pedals, each working separately; one for raising and another for lowering that part. But regarding the electric function of the hospital bed, an electric box is placed in the lower part of the patient's head area and the bed structure. This section has a number of electric wires or so-called electric power, which is connected to the desired port for power supply by the connector and connected to the power outlet with two plugs.

Located on the electrical box door, where the plug cable connects to the electrical box, is a three-plug connector that includes zero, phase, and earth, and next to the connector, there is a zero and one switch to cut off the electricity.

Inside the electric box there are two standard command boxes, which are related to opening and closing commands in hospital electric jacks. Each command box is responsible for commanding three jacks and can issue executive commands to all three jacks at the same time. On each control box, there are three inputs to connect to three jacks, and the two output wires of the electric jacks are connected to one of these inputs. And a built-in common power input is also considered to easily reverse the positive and negative current. The structure of the jacks is such that at their highest and lowest point, as soon as the load is added by the command box, the power connection order is cut off and they stop in place.

Inside the control boxes, there are relays that, after taking power from the city electricity and passing it through a 24 V step-down transformer that reduces the electricity flow from 220 V to 24 V, send the 24 V current to the jacks using the pedals (or buttons) as intermediary. In this way, two pedals are used to raise and lower each jack. By pressing one of the pedals, the jack moves down, and as soon as the other pedal of the same jack is pressed, due to the displacement of the positive and negative wires directed to the electric box, the jack moves up. As a result, you can stop the jack anywhere you want, but if the jack moves to the upper or lower limit by the pedal, based on previous descriptions, it stops at its final limit in a fraction of a second if more power is applied and will be ready for the reverse motion.

This type of circuit breaker is controlled by the control circuit located in the electrical box and includes the operation of cutting the current at the upper and lower limits. It is worth mentioning that if we are using jacks other than hospital jacks, we should either use the same circuit or command box, or use micro switches (small sensitive switches that cut off or connect the current) in the upper and lower limits of the jack's movement so the current can be cut off in our desired position of the jacks.

### Advantageous Effects

1) Saving Time
2) Faster recovery time of the patient
3) Mechanization of patient treatment procedures
4) Fewer personnel needed for these procedures in the ward
5) Preventing the patient from getting bruises and infections
6) Lowering the cost for the hospital by lowering the number of personnel needed
7) Eliminating labor hardship for medical professionals

### BRIEF DESCRIPTION OF DRAWINGS

FIG. 1: Exploded view of the pieces with the details listed below.

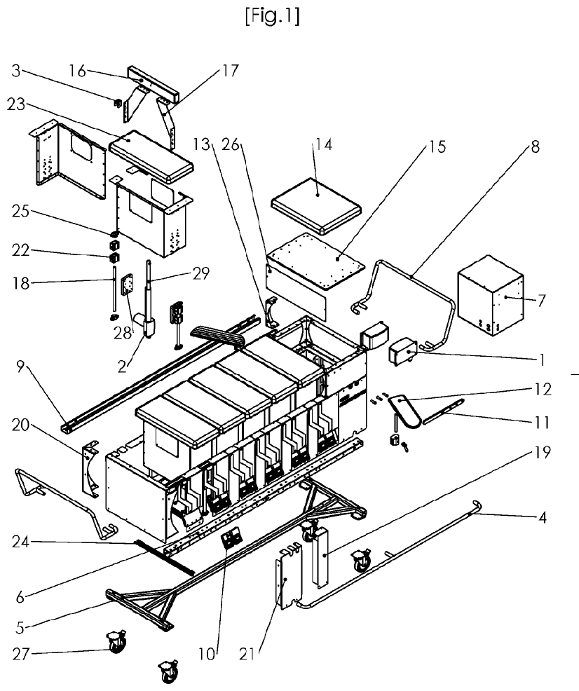

FIG. 2: Overview of the bed

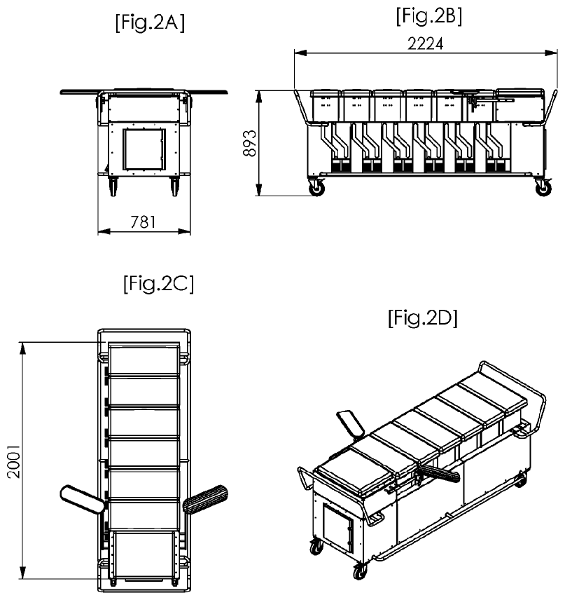

FIG. 3: Eyelet connecting the jack's main axle

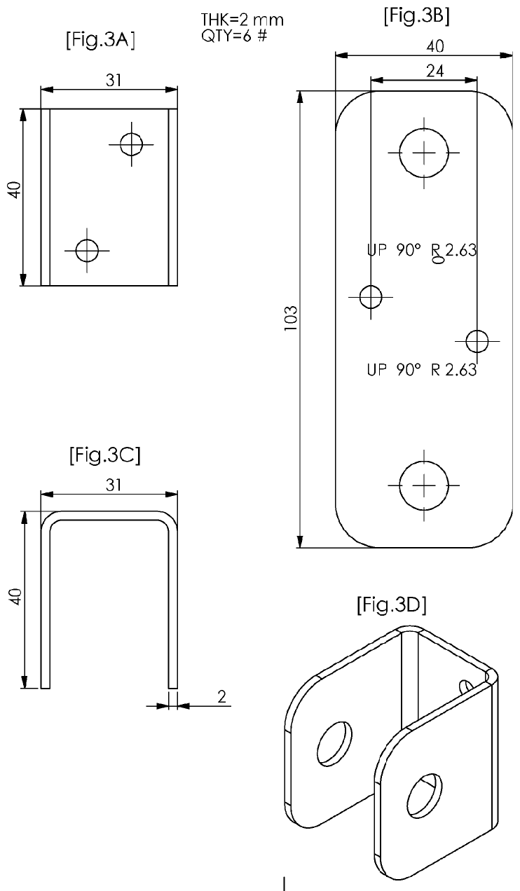

FIG. 4: Support base

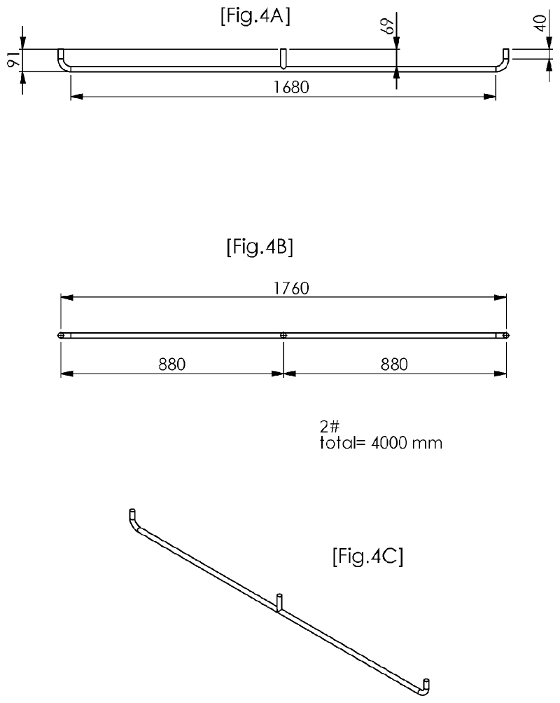

FIG. 5: Main base structure overview

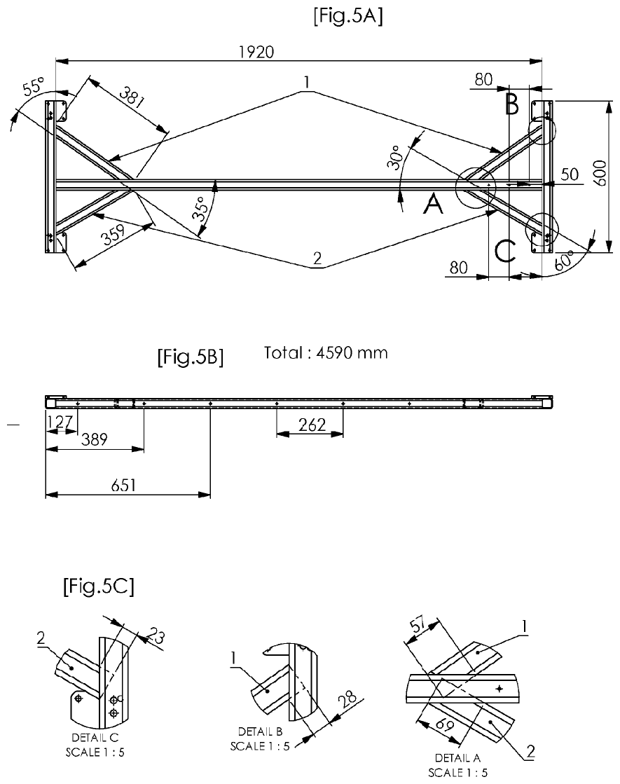

FIG. 6: Longitudinal pillars of the lower structure

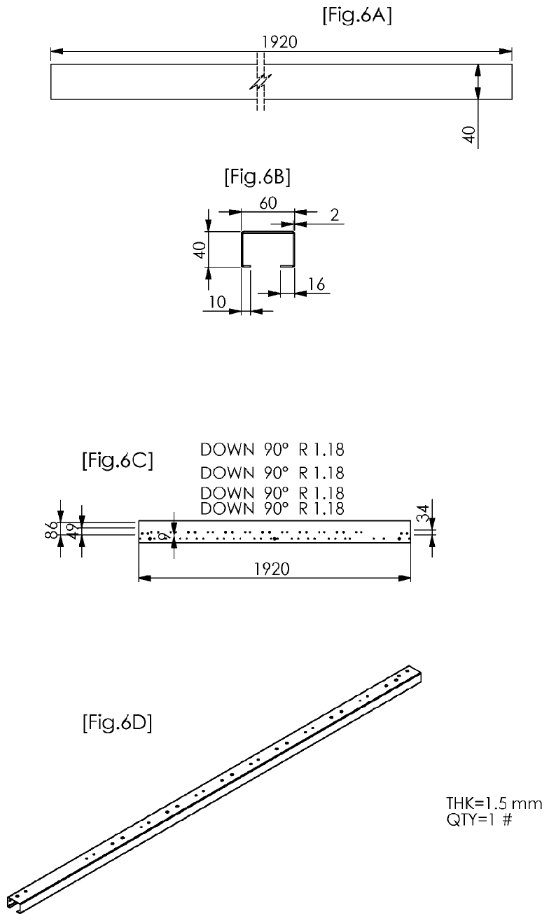

FIG. 7: Main power box

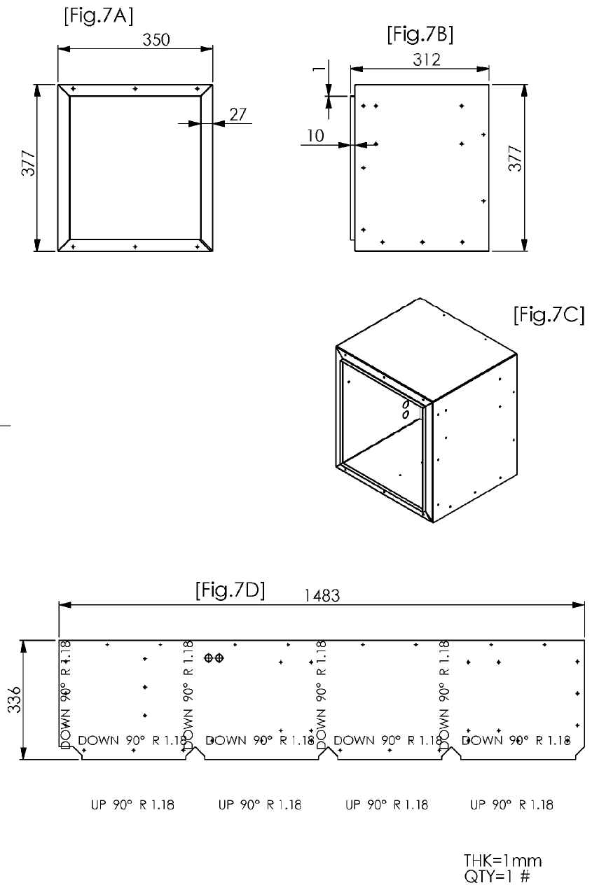

FIG. 8: Handle

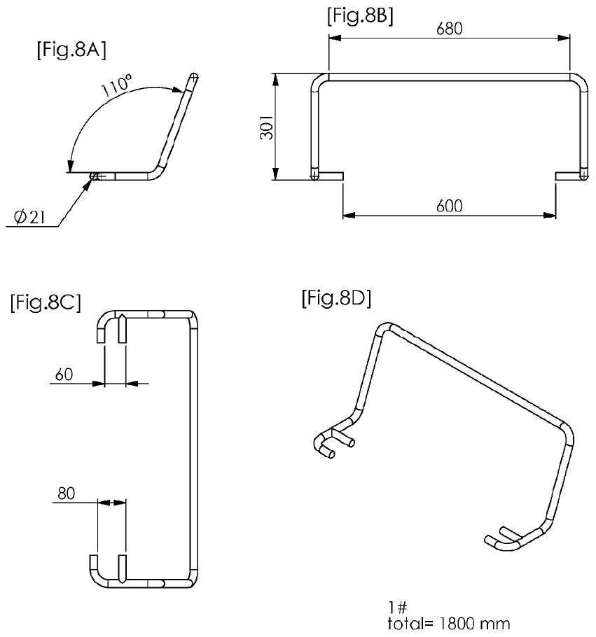

FIG. 9: Longitudinal pillars of the upper structure

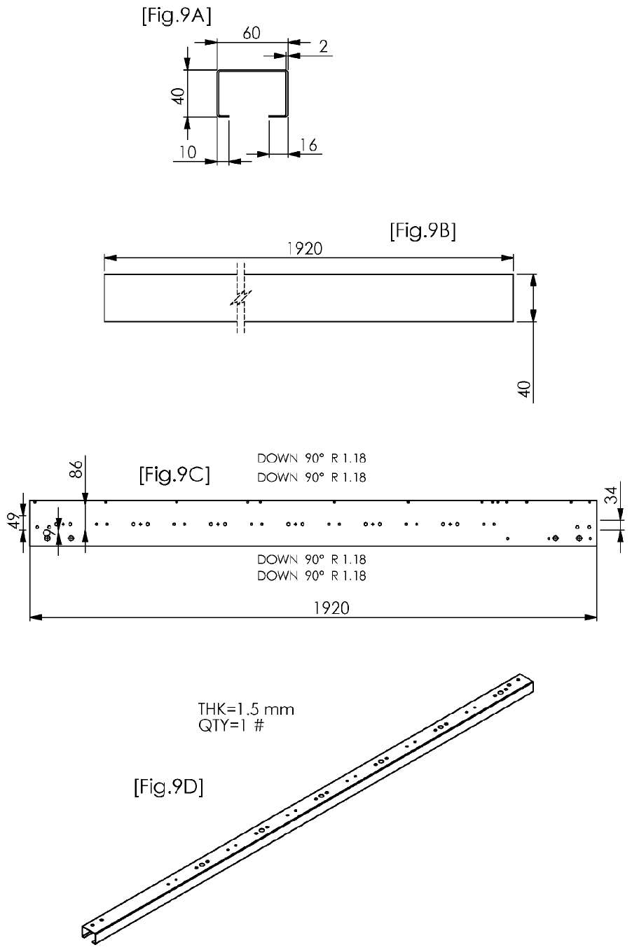

FIG. 10: Rail used as the patient's hand stand

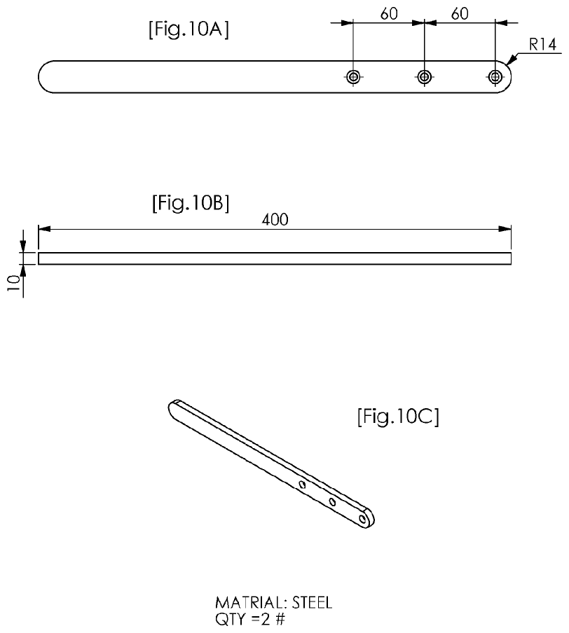

FIG. 11: Mattress for patient's arm

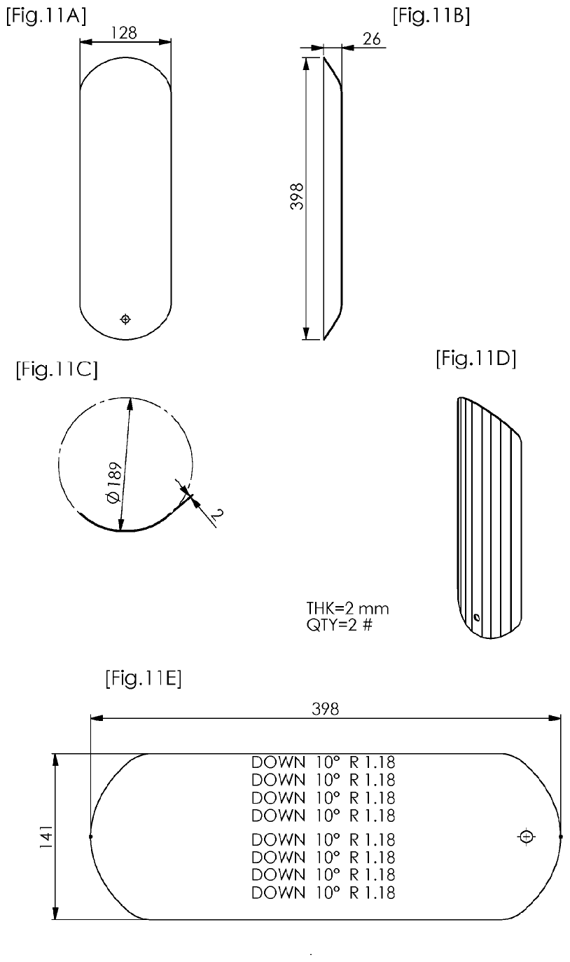

FIG. 12: L support bracket used for connecting the plates

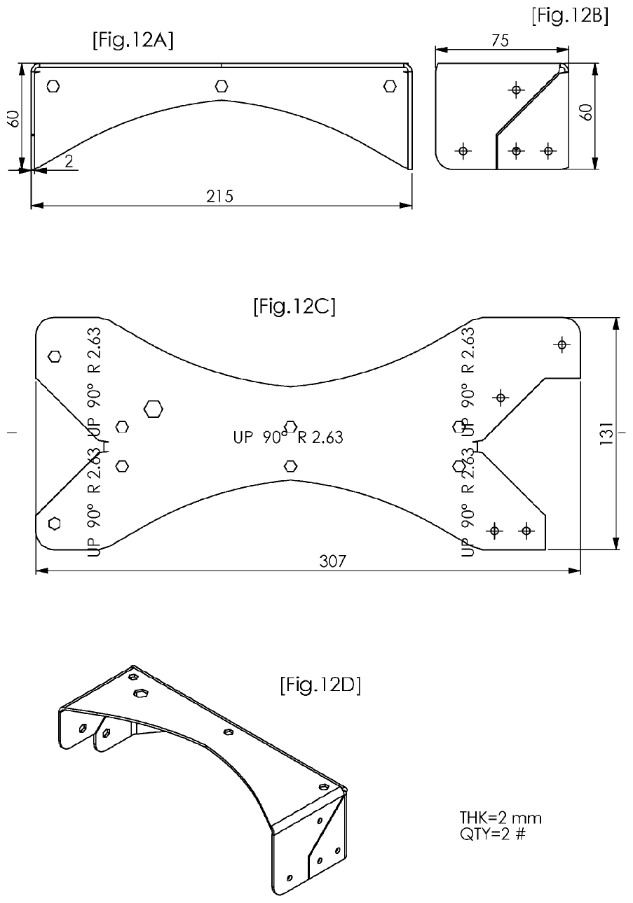

FIG. 13: Fixed head rest mattress

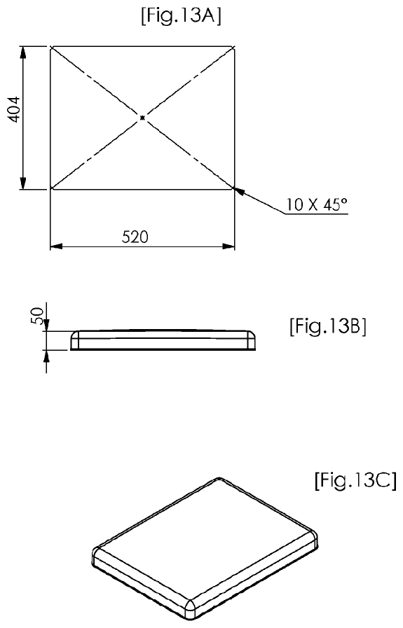

FIG. 14: Fixed plate under the pillow

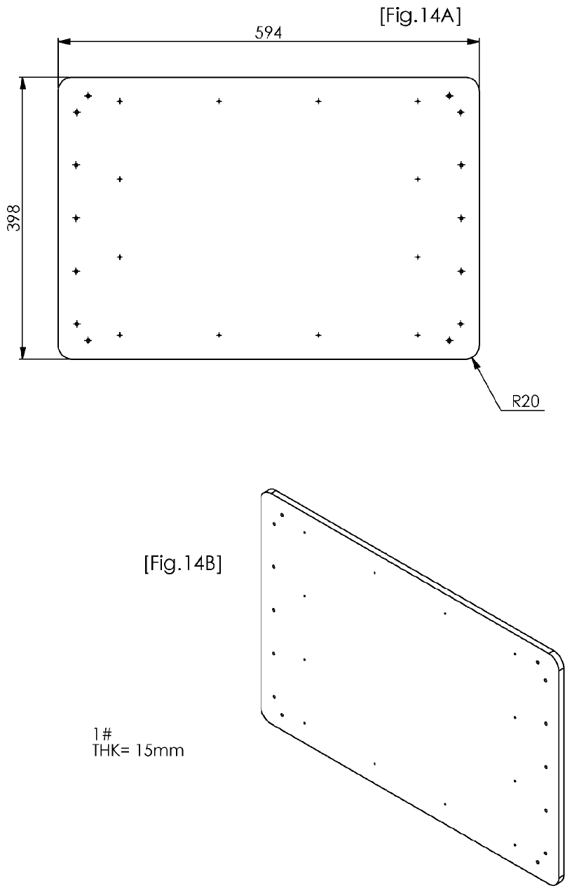

FIG. 15: Lifting jack handle shield (Latitudinal ascending reinforcer)

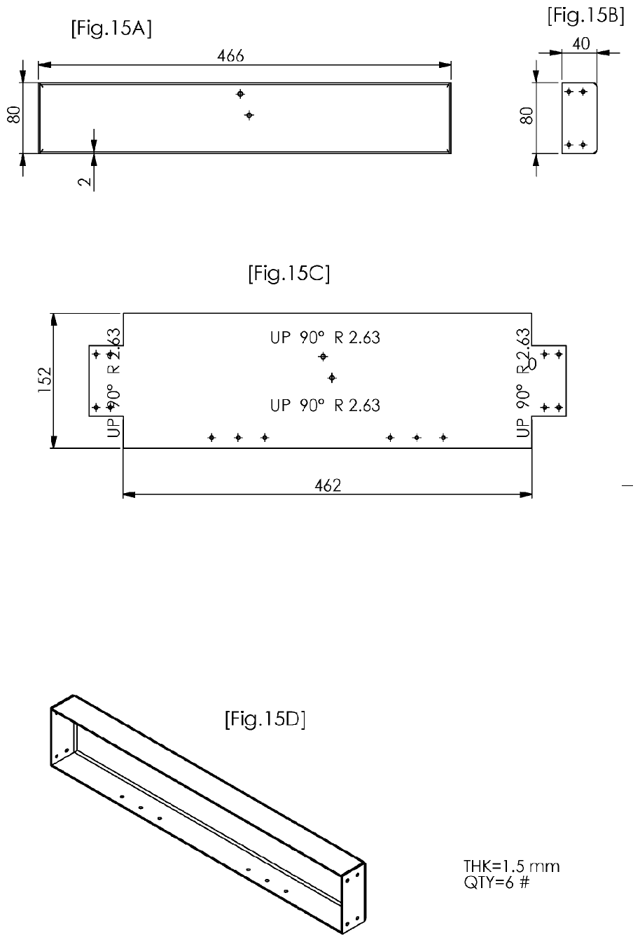

FIG. 16: Handle connecting to the shield and upper part of the jack (Ascending reinforcer plate)

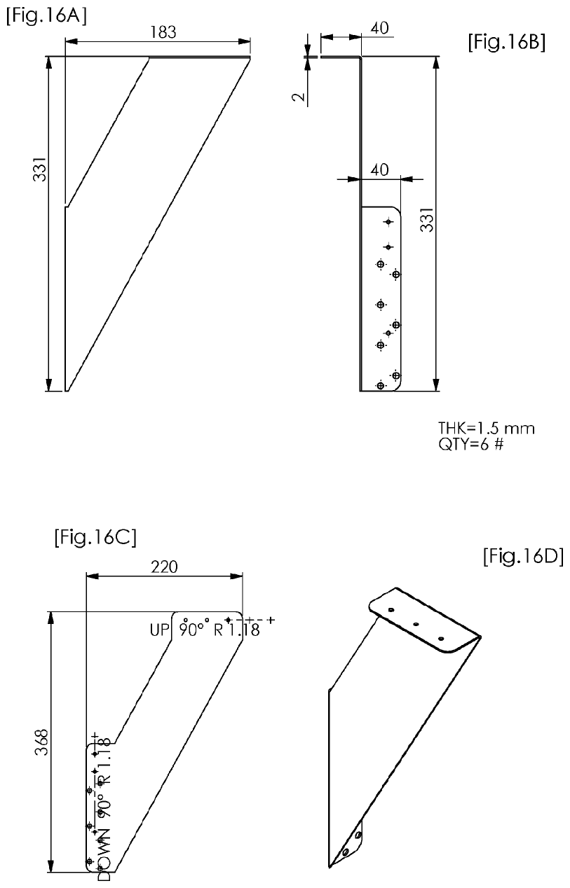

FIG. 17: Covering plate between the pedals

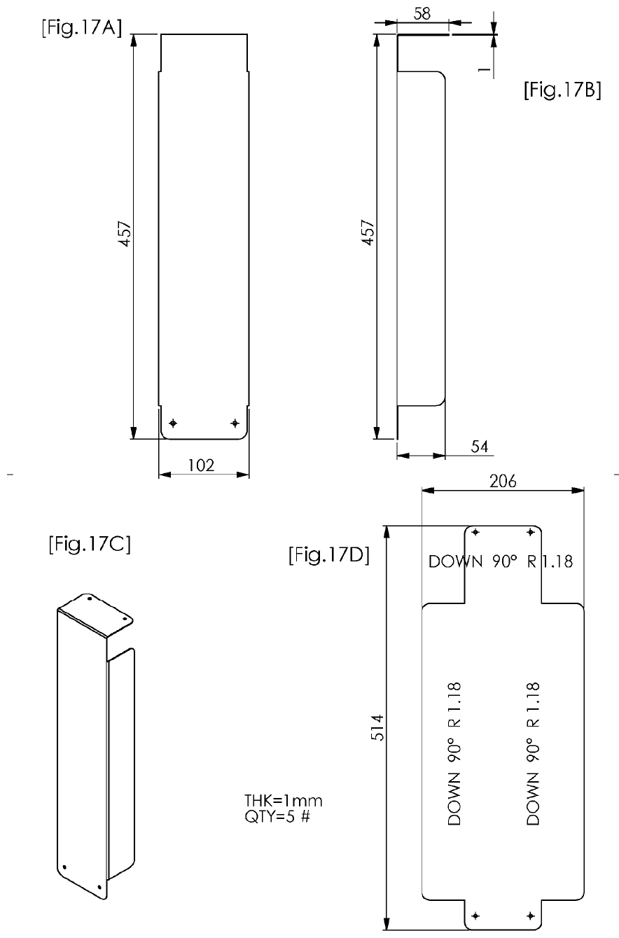

FIG. 18: L support bracket connecting the corners of the main structure

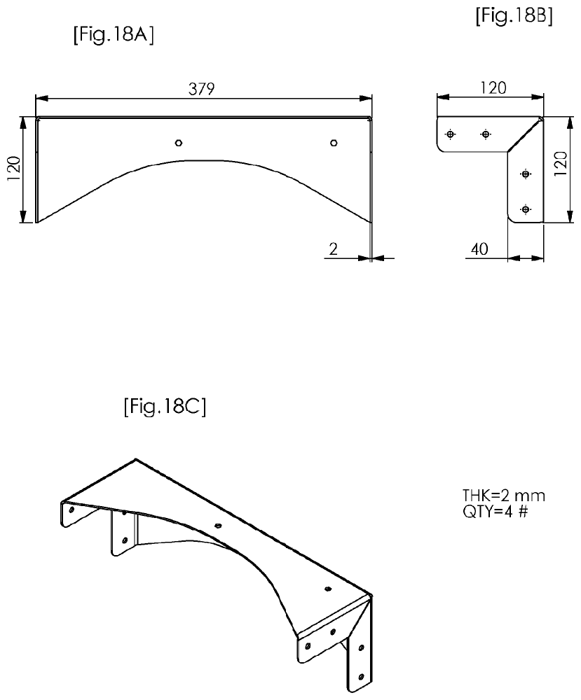

FIG. 19: Cover

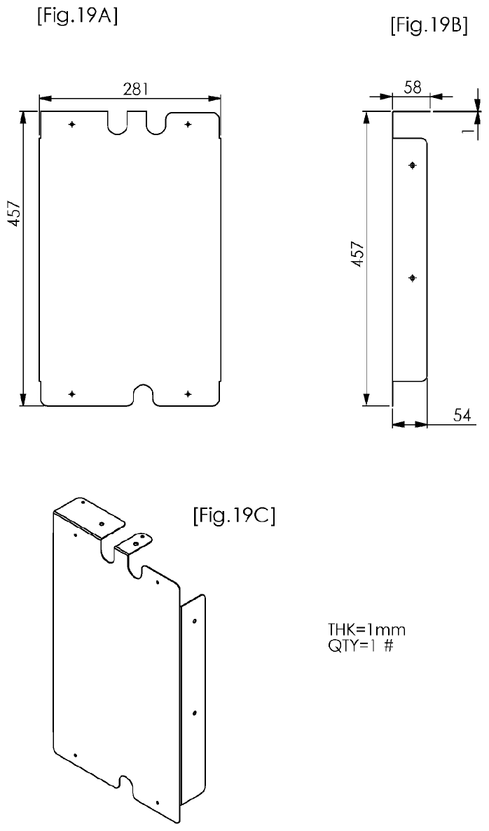

FIG. 20: Moving mattress overview

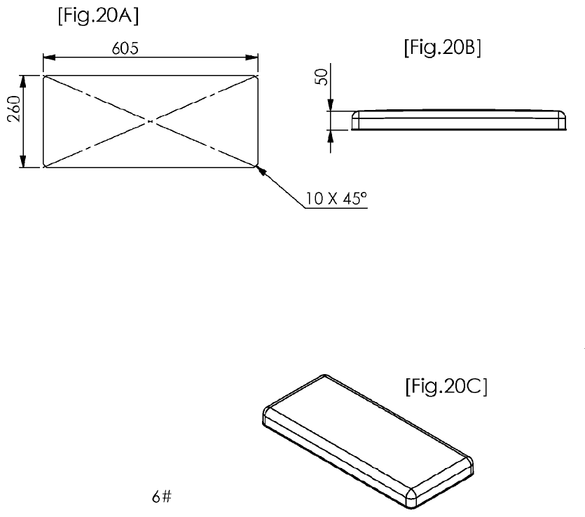

FIG. 21: Latitudinal structures overview

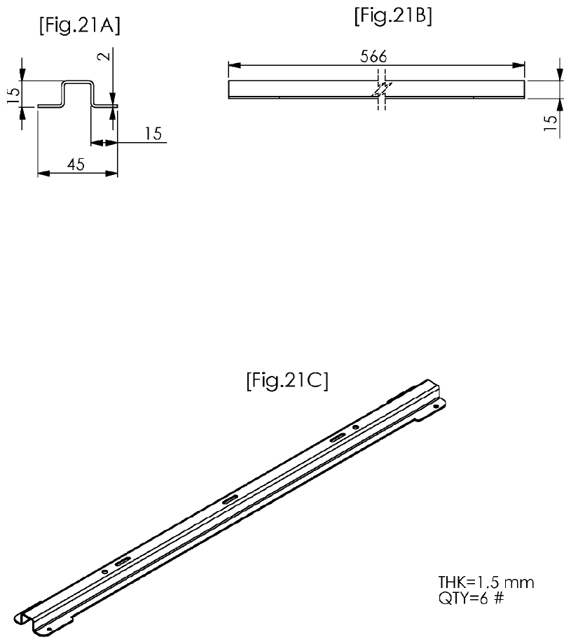

FIG. 22: Cover for fixed parts

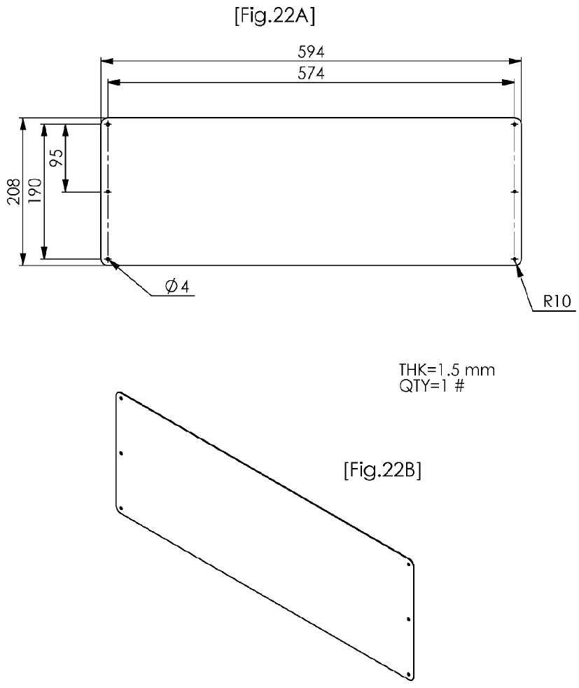

### DESCRIPTION OF ELEMENTS

Piece number 1: Control box
Piece number 2: Gearbox motor shell of the jack
Piece number 3: Eyelet connecting the jack's main axle
Piece number 4: Support base
Piece number 5: Main base structure
Piece number 6: Longitudinal pillars of the lower structure
Piece number 7: Main power box
Piece number 8: Handle
Piece number 9: Longitudinal pillars of the upper structure
Piece number 10: Electric pedal
Piece number 11: Rail used as the patient's hand stand
Piece number 12: Mattress for patient's arm
Piece number 13: L support bracket used for connecting the plates
Piece number 14: Fixed head rest mattress
Piece number 15: Fixed plate under the pillow
Piece number 16: Lifting jack handle shield (Latitudinal ascending reinforcer)
Piece number 17: Handle connecting to the shield and upper part of the jack (Ascending reinforcer plate)
Piece number 18: Guide pin
Piece number 19: Covering plate between the pedals
Piece number 20: L support bracket connecting the corners of the main structure
Piece number 21: Cover
Piece number 22: Guide bushing
Piece number 23: Moving mattress
Piece number 24: Latitudinal structures
Piece number 25: Shaft head
Piece number 26: Fixed part cover
Piece number 27: Wheels
Piece number 28: Flange connecting jack and box (Intermediary between guide bushing and ascending part)
Piece number 29: Jack shaft with nut

The nurse can press the small pedal (30) on the left which will cut the mechanism designed to keep the pillow raised and the pillow will come down. After finishing bandage procedures, the nurse can now press the big pedal (10) to return the right side of the pillow to its first position and repeat this process for different parts. During the whole process, the nurse does not need to touch the bed and can easily go through bandage replacement process without the help from other personnel.

### Industrial Applicability

This bed is used in specialized centers for burn patients.

1. A multi-part hospital bed in which every part is moveable is consisted of main frame, a separate box for each part, jack, guide pin, bushing, shaft, the flange between the bushing and each box, electric pedal and the control box wherein electric pedals can be pushed to move any part up and down using the jack.

2. The multi-part hospital bed recited in claim 1, the main frame is designed in the shape of a cuboid and situated in the middle of the bed which is where the jacks are located wherein longitudinal pillars are located on both sides of the main frame in order to install the guide pins.

3. The multi-part hospital bed recited in claim 1, wherein under every piece of a six-piece mattress is a box which has an eyelet used to connect the jack's axle to the box to transfer the power from the jack to every moveable part of the bed.

4. The multi-part hospital bed recited in claim 1, wherein the longitudinal pillars of top and bottom of the bed include guide pins are situated using shafts.

5. The multi-part hospital bed recited in claim 4, further comprising two bushings that can move up and down.

6. The multi-part hospital bed recited in claim 5, wherein the two bushings are connected to the body of the box using an aluminum flange which contribute to smooth vertical movement of every piece.
